(19) United States
(12) Patent Application Publication
(10) Pub. No.: US 2019/0310344 A1
(43) Pub. Date: Oct. 10, 2019

(54) WIRELESS POSITIONING SYSTEMS

(71) Applicants: Peyman Moeini, Thornhill (CA); Akbar Ahmari, Toronto (CA); Dishan Fernando, Mississauga (CA); Sammy Guergachi, Oakville (CA)

(72) Inventors: Peyman Moeini, Thornhill (CA); Akbar Ahmari, Toronto (CA); Dishan Fernando, Mississauga (CA); Sammy Guergachi, Oakville (CA)

(21) Appl. No.: 16/298,819

(22) Filed: Mar. 11, 2019

Related U.S. Application Data
(60) Provisional application No. 62/640,645, filed on Mar. 9, 2018.
(60) Provisional application No. 62/640,646, filed on Mar. 9, 2018.
(60) Provisional application No. 62/640,649, filed on Mar. 9, 2018.
(60) Provisional application No. 62/640,651, filed on Mar. 9, 2018.

(51) Int. Cl. G01S 5/14; H04W 64/00; H04W 76/11; G06T 11/20

(52) U.S. Cl. CPC G01S 5/145; G06T 11/20; H04W 76/11; H04W 64/003

(57) ABSTRACT

A wireless positioning system including a method for dynamically spatially visualizing in real time or historically tag localization and sensing data in a user interface through combined GUI elements of a floor layout view. The method includes the steps of visually indicating tags as colored dots on an indoor map view moving within boundaries of readers wherein localization data from these tags are used to position and move them in a spatially accurate way. The method also includes using playback controls of GUI which allows for pausing or to instantly view historical tag localization and sensing data by dragging the playback control's scrubber backwards in time.

### CROSS-REFERENCE TO RELATED APPLICATION

This application claims the benefit of U.S. Provisional Patent Application Ser. No. 62/640,645 filed Mar. 9, 2018, U.S. Provisional Patent Application Ser. No. 62/640,646 filed Mar. 9, 2018, U.S. Provisional Patent Application Ser. No. 62/640,649 filed Mar. 9, 2018, and U.S. Provisional Patent Application Ser. No. 62/640,651 filed Mar. 9, 2018.

### BACKGROUND OF THE INVENTION

### Field of the Invention

The present invention is directed to wireless positioning systems.

### SUMMARY OF THE INVENTION

It's one object of the present invention to provide a graphical user interface (GUI) geared specifically towards providing a visual map of an indoor floor.

It's another object of the present invention to provide such a GUI that allows for a very elegant way to visualize in real time or historically via playback the localization and sensory data acquired from tags.

It's yet another object of the present invention to provide a GUI that allows the creation of automated workflows.

Lastly, it's an object of the present invention to present an overarching GUI that allows for a cohesive way to navigate to these presented GUIs.

### BRIEF DESCRIPTION OF THE DRAWINGS

FIG. 1 is the Sign In screen.

FIG. 2 is the Floor Layout screen that appears once signed in.

FIG. 3 shows the Navigation Panel accessible from every screen, in this case from Floor Layout screen.

FIG. 4 shows the Zone Panel which appears once a Zone is selected in the Floor Layout screen.

FIG. 5 shows the Thing Panel which appears once selecting a Thing in Floor Layout, as well as how Panels can slide on top of one another, in this case the Thing Panel on top of the Zone Panel.

FIG. 6 shows the Tag Settings Panel.

FIG. 7 shows the Activity Panel accessible from any screen, in this case from the Floor Layout screen.

FIG. 8 shows the Tag Management Screen with the name field being filled out.

FIG. 9 shows the Tag Management Screen with the Thing name and Tag ID fields filled out and the Link button appearing.

FIG. 10 shows the Zone Editor.

FIG. 11 shows the result of importing Zones into the Zone Editor.

FIG. 12 shows what happens when selecting a Zone in the Zone Editor.

FIG. 13 shows a cursor selecting the vertex of a selected Zones in the Zone Editor.

FIG. 14 shows a cursor Resizing Zone by dragging Vertex in Zone Editor.

FIG. 15 shows the resized Zone in the Zone Editor.

FIG. 16 shows the GUI to rename a Zone in the Zone Editor.

FIG. 17 shows the GUI for creating the first Zone vertex in Zone Editor.

FIG. 18 shows the GUI for creating the second Zone vertex in Zone Editor.

FIG. 19 shows the GUI for creating the third Zone vertex in Zone Editor.

FIG. 20 shows the GUI for creating the fourth Zone vertex in Zone Editor.

FIG. 21 shows the GUI for linking back the fourth Zone vertex to the first Zone vertex in Zone Editor.

FIG. 22 shows the final shape of the new Zone in Zone Editor.

FIG. 23 shows the GUI for naming a new Zone in Zone Editor.

FIG. 24 shows the Automation Center screen.

FIG. 25 shows the New Flow Panel in the Automation Center screen.

FIG. 26 shows the GUI for setting a Trigger in the New Flow Panel.

FIG. 27 shows the GUI for setting an Action in the New Flow Panel.

FIG. 28 shows the Add Users Panel.

FIG. 29 shows selecting users in the Add Users Panel.

FIG. 30 shows the Notify Users Action in the New Flow Panel filled with users.

FIG. 31 shows the GUI for setting the scope in the New Flow Panel.

FIG. 32 shows the Add Things Panel.

FIG. 33 shows selecting Things in the Add Things Panel.

FIG. 34 shows the Things scope with added Things in the New Flow Panel.

FIG. 35 shows the GUI when scrolling down New Flow Panel to Zones Scope.

FIG. 36 shows the Add Zone Panel.

FIG. 37 shows selecting Zones in Add Zone Panel.

FIG. 38 shows the Zone Scope with added Zone in the New Flow Panel.

FIG. 39 shows the GUI when scrolling down the New Flow Panel to the Finalize section.

FIG. 40 shows the GUI when selecting an effect in the New Flow Panel.

FIG. 41 shows the new Flow added to Flow list.

### DETAILED DESCRIPTION OF Tit E INVENTION

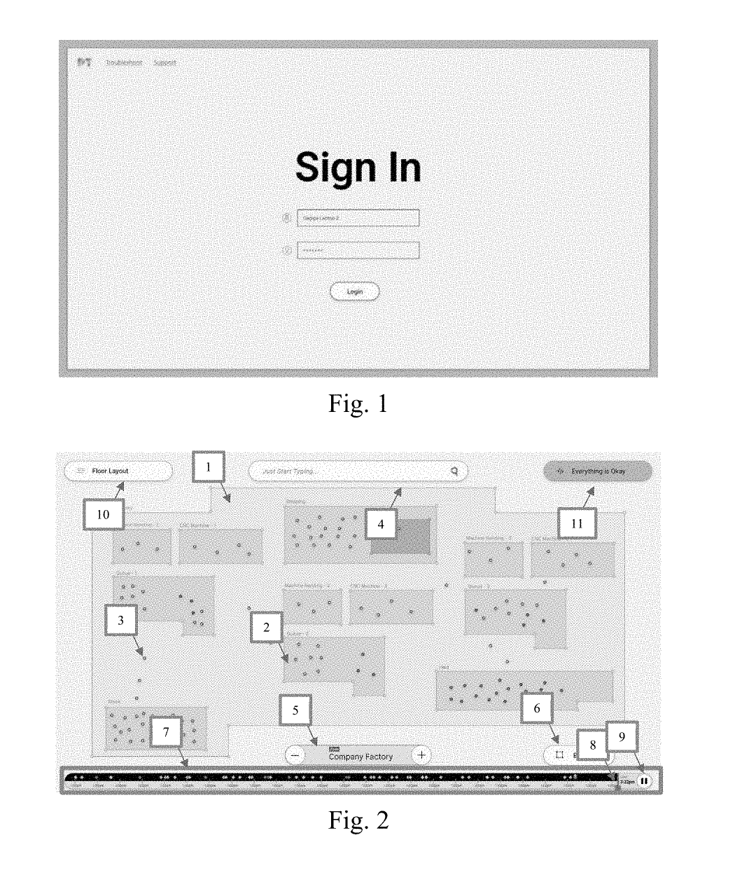

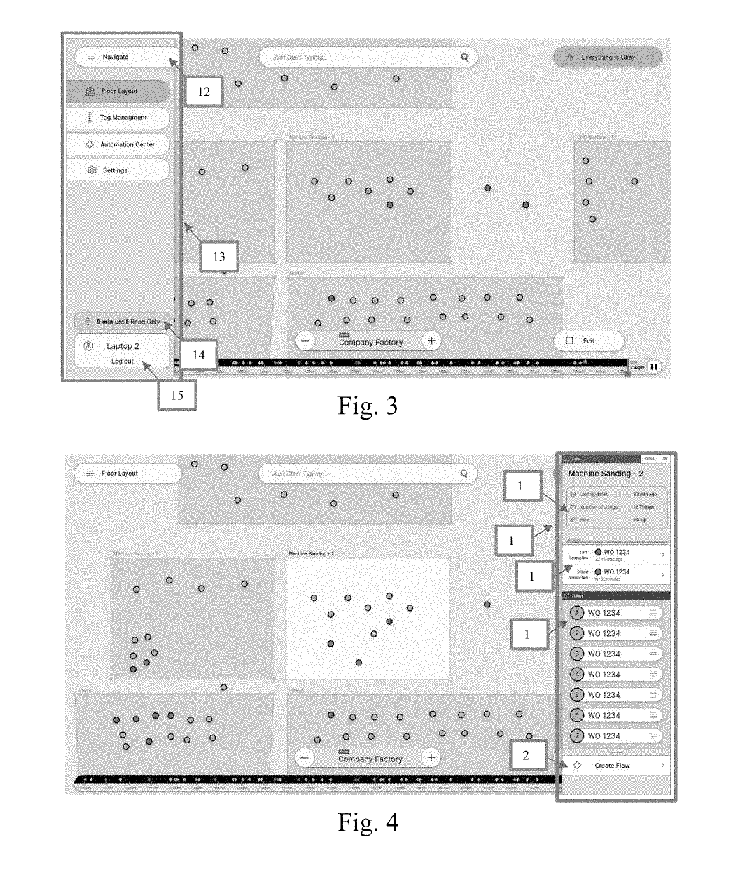

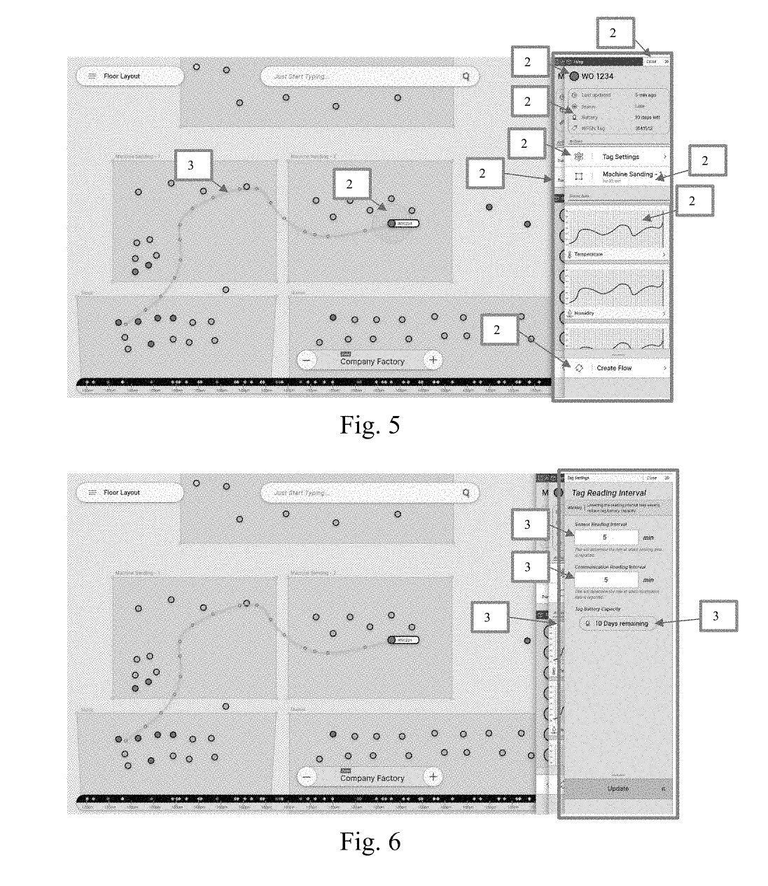

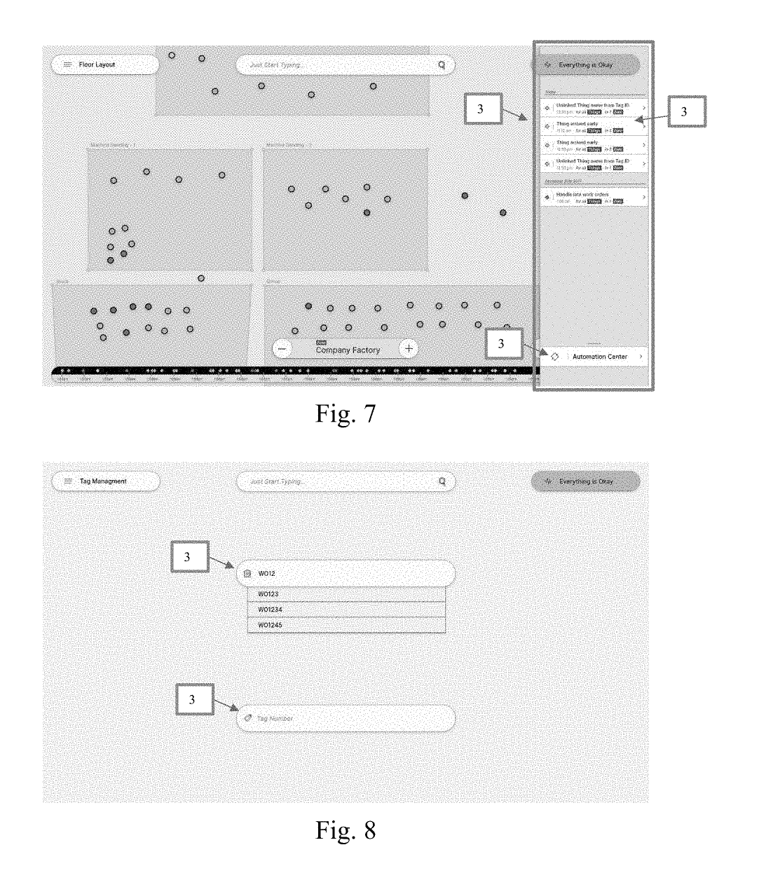

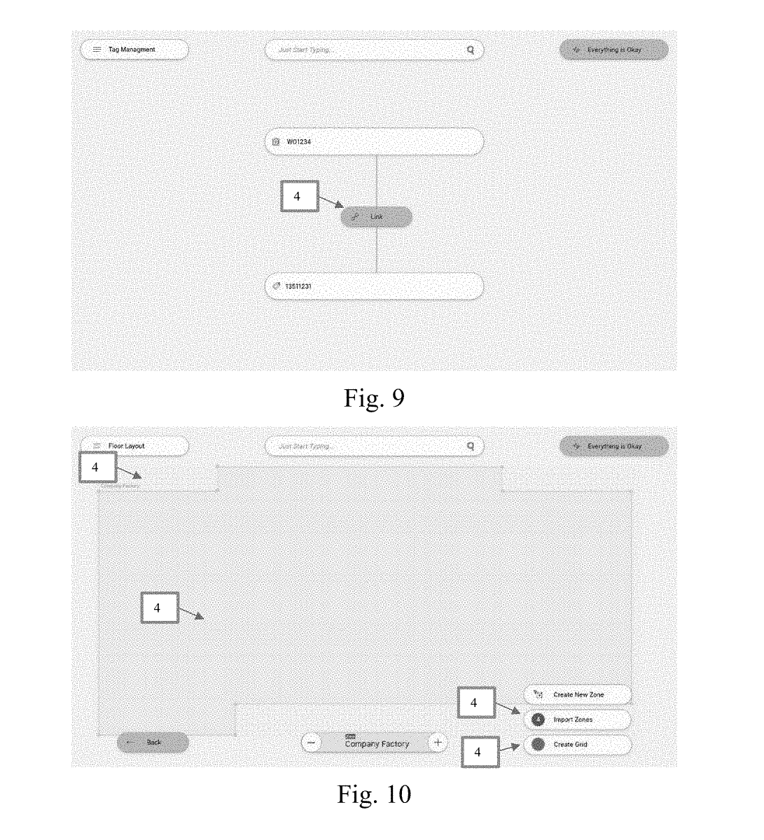

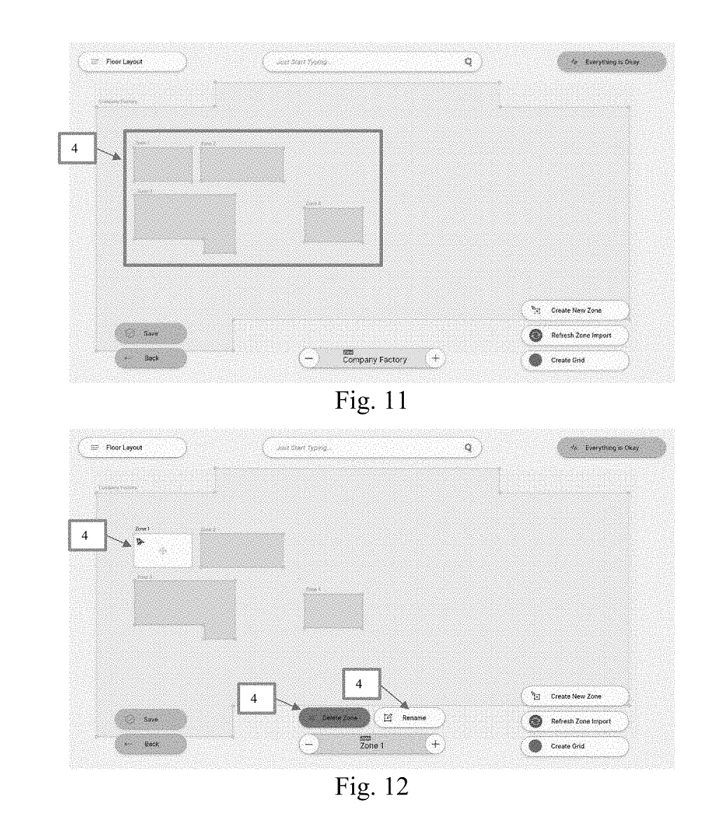

To access SIMS, we require users to login with an account (FIG. 1). The accounts are created and managed by the end user. A user can be either a regular user, with some features hidden and access set to read-only, or an admin user, with access to all features without editing restrictions.

After login in we show the user a full view of the floor layout contained in the parent zone (FIG. 2). The parent zone (1) is the zone that contains all child zones (2) on a specific floor. We depict tags in the form of colored dots (3) which move in real time in and around child zones. Users can search for zones and tags via a search bar (4). The current zone in focus is determined by how far zoomed in our out the user is into the floor layout, this is displayed in the zoom control bar (5). To edit zones users must press the edit button (6). To go back in history users can use the playback control bar (7) and drag the scrubber (8) back in time. The colored diamonds in playback control bar represent historical activity. the Users can also pause real-time update of tags localization using the pause button (9). To navigate to other screens users must press the navigation button (10). To view the activity panel users must press the status button (11).

When users click the navigation button (12) the navigation panel will slide into view (13). Users without admin accounts can access restricted features and make edits for a limited time by entering a password in the navigation panel, the time after entering the password until the restrictions are put back in place is displayed (14). Users can log out by clicking the logout button (15).

When users select a zone the Zone Panel slides into view (16). The zone panel shows metadata about the zone (17). It allows users to view the last and oldest transaction through the zone (18). Transactions happen when a tag enters or leaves a zone. The Zone Panel contains all a list of Things ordered chronologically or by user (19). Things represent the tagged objects being tracked on the Floor Layout which can be named by users. Users can create Flows from the Zone Panel (20).

When selecting a Thing the Thing Panel slides into view (21). If a Panel is already in view, a new Panel will slide on top of the previous panel. Users can view the previous Panel by dismissing the current panel (22) or by selecting the previous Panel. The Thing Panel indicates the state of the Thing based on color (23). The Thing Panel contains metadata about the selected Thing (24). It contains the ability to edit settings for the Thing's Tag (25). It contains the ability to select the Zone the Thing is within (26). It contains graphs representing sense data tracked by the Things tag (27). It contains the ability to create a Flow with the selected Thing as the scope (28). The selected thing in the Floor Layout expands to show the name of the Thing along with a dynamic uncertainty radius depicting the area where the tag is located based on the Reader's ability to localize the tag (29). The selected Thing also shows its historical positions via a path leading up to the Thing with dots along the path representing when localization data on the tag was received (30).

After clicking the Tag Settings button in the Tag Panel, the Tag Settings Panel slides out (31). In the Tag Settings Panel users can edit the sensor reading interval and the communication reading interval (32,33). Changing these reading intervals affects the time to drain the tag's battery (34).

When the user clicks on the Status button the Activity Panel slides out (35). The Activity Panel contains chronologically ordered Activity generated by Flows (36). Activity represents a log of a triggered Flow, showing the Flow's name, the Flow's scope, the Flow's triggering timestamp, and the Flow's effect. Selecting an Activity will show the associated Flow's Panel. Users can access the Automation Center from the Activity Panel (37).

In the Tag Management screen (FIG. 8), users scan name their Things by typing in the name they want to assign it at the top (38). And the Tag ID found on the physical Tag at the bottom (39).

When the Thing's name and the Tag ID is inputted by the user, they can link both by clicking the link button (40). Linking a name to a Tag ID will change the Thing's name from previously being the Tag ID to the inputted name.

When users select the Edit button in Floor Layout (FIG. 2) they are taken to the Zone Editor which should have a Parent Zone (41). The Zone Editor depicts the extent of the Readers through the light gridded area in the background (42). This gridded area is therefore the boundary within which users can draw Zones. Zones are user defined areas on a floor monitored by Readers. Users can collect Zones using a hand-held Clicker Tag which would save Zone positions to be imported using the Import Zones button in the Zone Editor (43). Users can define a grid inside their Parent Zone by selecting the Create Grid button (44). When users click the Import Zones button (FIG. 10) the collected Zones populate the Parent Zone (45).

Users can drag a Zone by first clicking on it, then dragging it (46). Zones can not overlap one another. Users can Delete or Rename using the Delete Zone and Rename button after selecting a Zone (47,48).

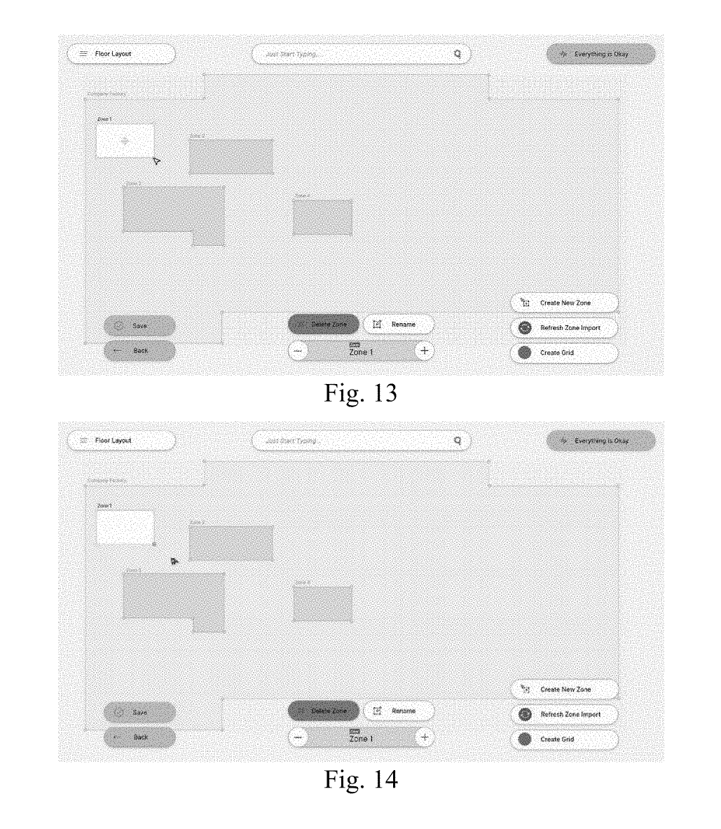

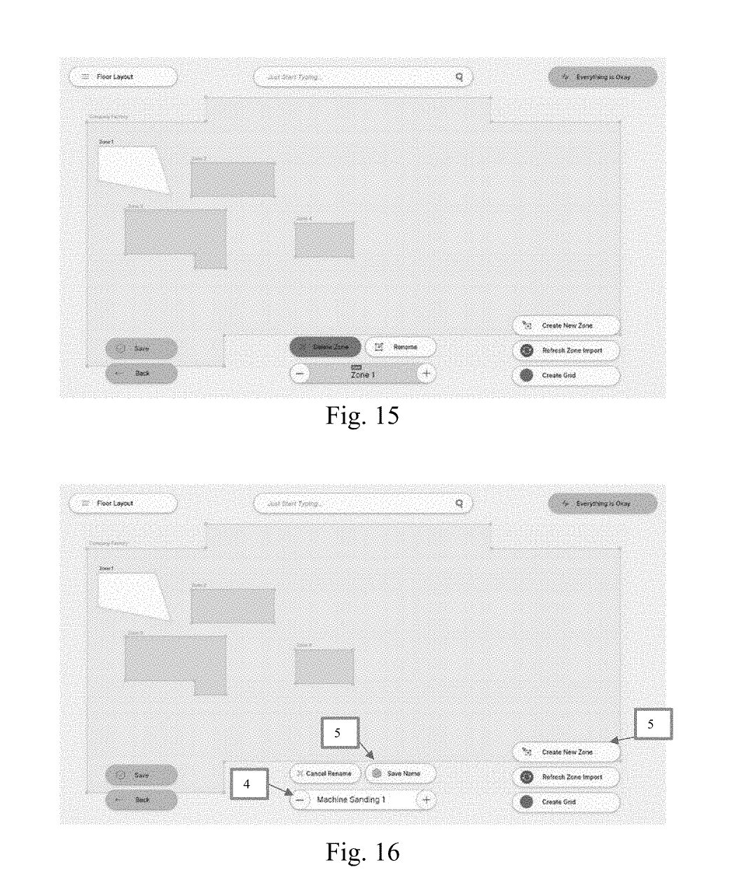

Users can resize a Zone by selecting a vertex of a selected Zone (FIG. 13) then dragging the vertex to a desired location (FIG. 14). The result is a transformed Zone (FIG. 15).

When users click the Rename button in the Zone Editor (FIG. 12) they will be able to type in a new name for the Zone (49) and save it by clicking the Save Name button (50). Users can create a new Zone by clicking the Create New Zone button (51).

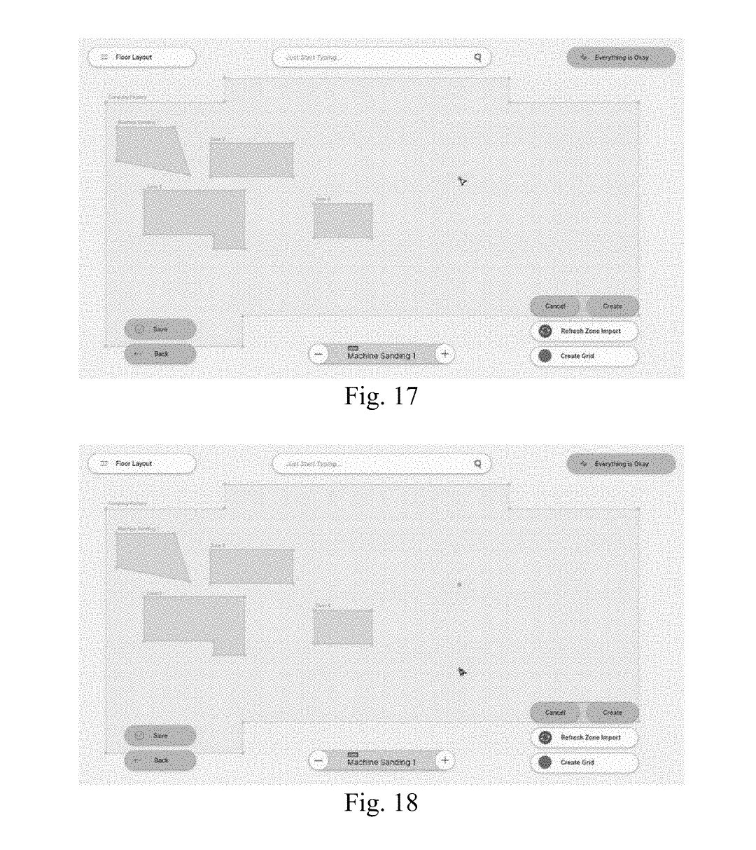

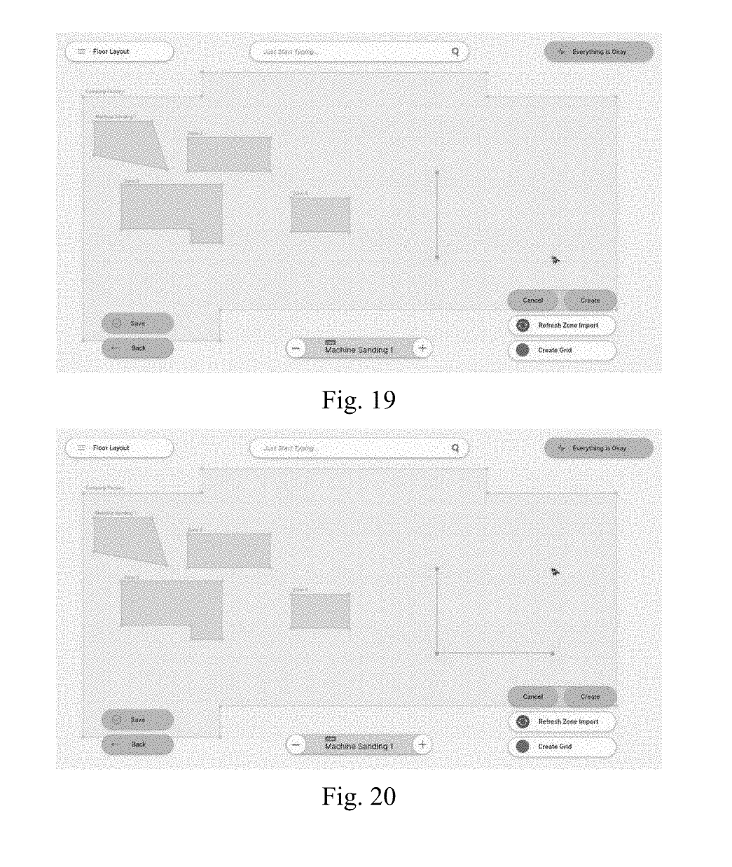

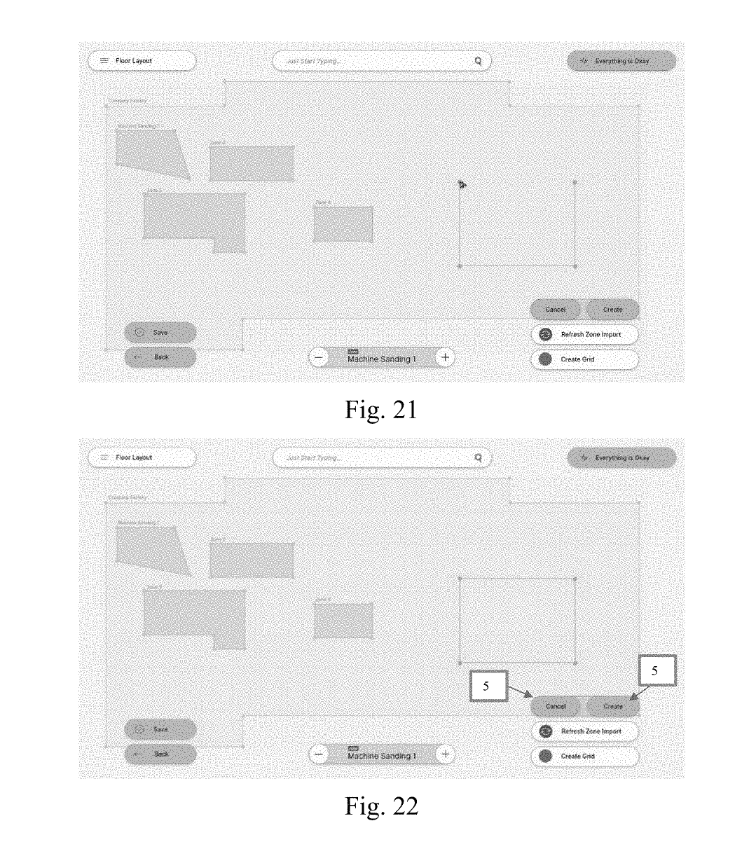

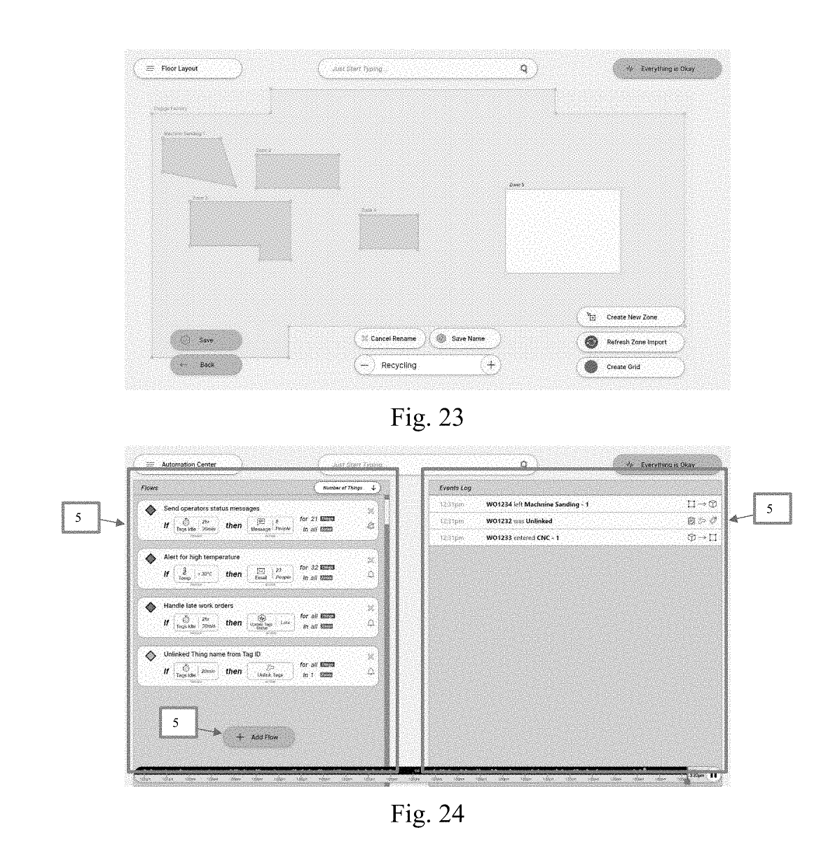

After clicking the Create New Zone button (FIG. 16) users can create a Zone by placing as many vertecies as they want (FIG. 17-22). Once done (FIG. 22) users can create the Zone by clicking on the Create button (52) or cancel to get out of Zone creation mode (53). After users click Create (52) they can name the Zone (FIG. 13).

When users go into the Automation Center they are shown a list Flows (53) and an Events Log (54). The list of Flows shows the Flow effect (which is the positive or negative connotation a Flow would have once triggered), a name for the Flow, the trigger and resulting action of the Flow, the scope of the Flow in terms of number of Tags and Zones encompassed by the Flow. Users can add a Flow by clicking the Add Flow button (55).

Once users click the Add Flow button, the New Flow Panel slides out (55). Users can select a Trigger for the flow from a predefined set of Triggers (56). Triggers are the criteria that needs to be met before an Action is triggered. Users can similarly pick from a predefined list of Actions (57).

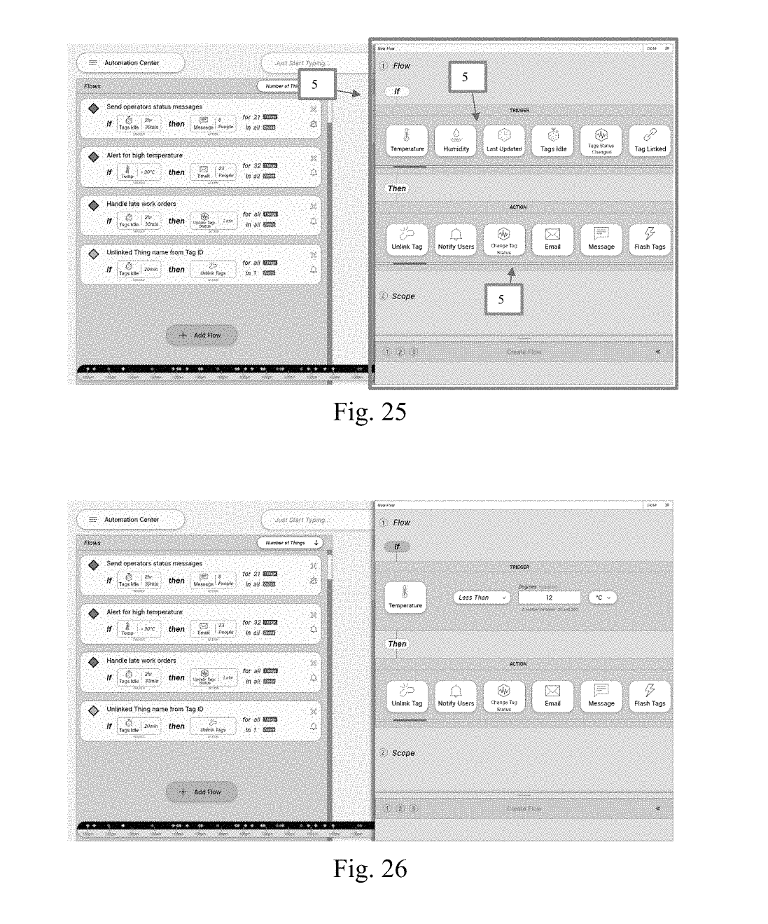

When users select a Trigger (FIG. 25) they are required to provide values to set up the desired criteria used to evaluate when a Flow is triggered, in this example (FIG. 26) Temperature is the selected Trigger.

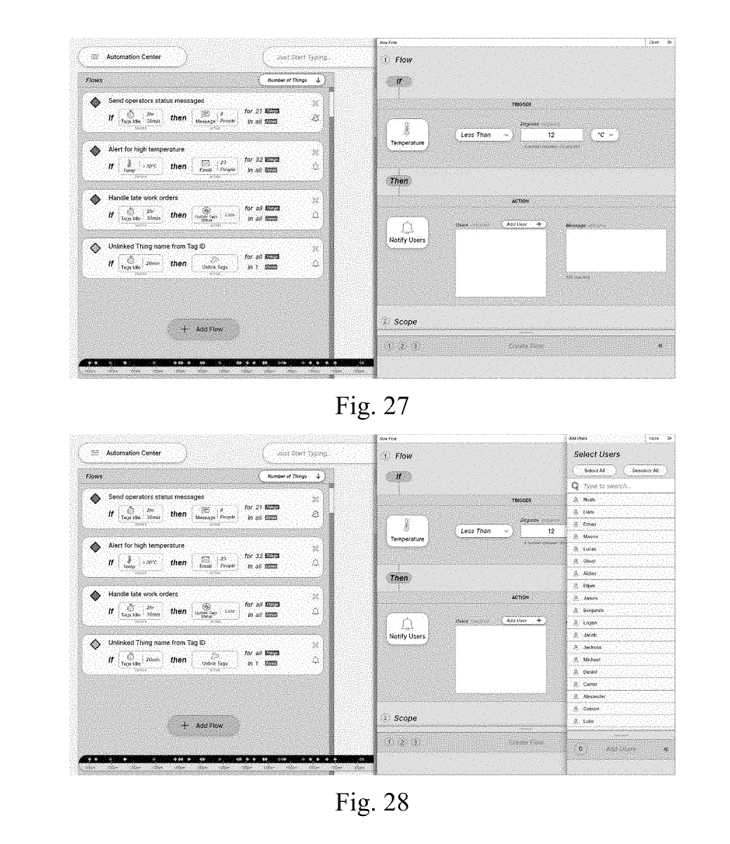

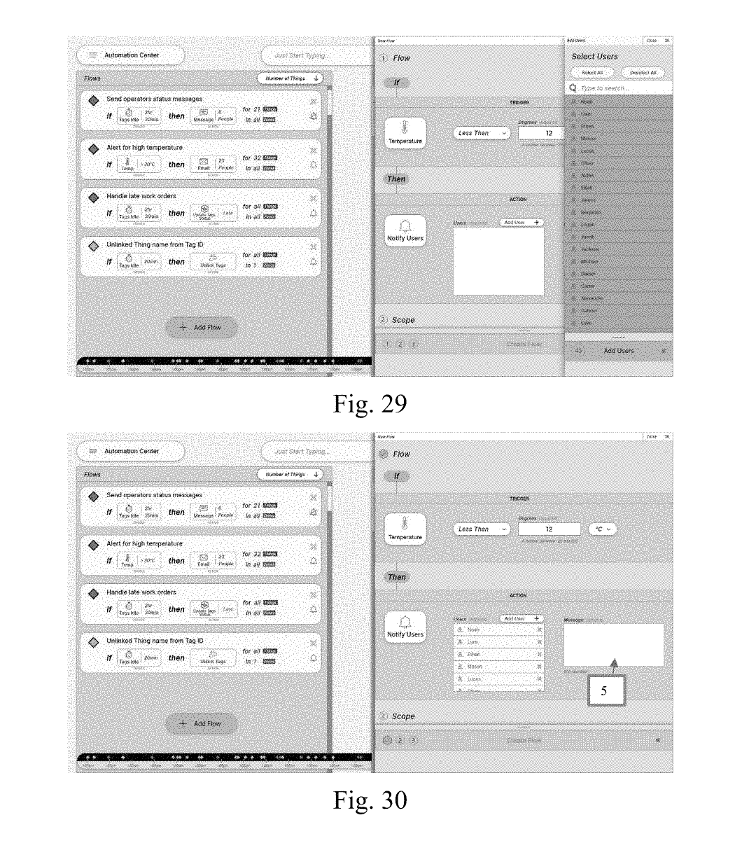

When users pick an Action for their Flow (FIG. 25) they can sometimes decide that the Action applies to a set of users (FIG. 27), for example the Notify Users Action requires users add a set of users using the Add Users Panel (FIG. 28, FIG. 29) to be notified of a specific message (57).

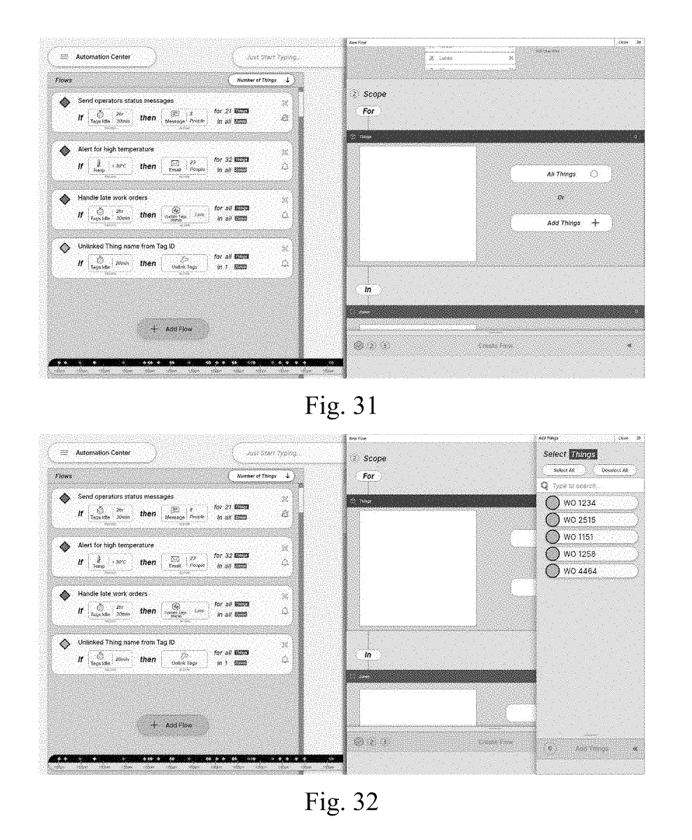

Scrolling down the New Flow Panel, once done setting the Trigger and Action, users will need to set the scope of the Flow (FIG. 31), meaning the specific Things and Zones in which the Flow will apply. This adds another criterion to the Flow by specifying what Things and in what Zones the trigger may apply.

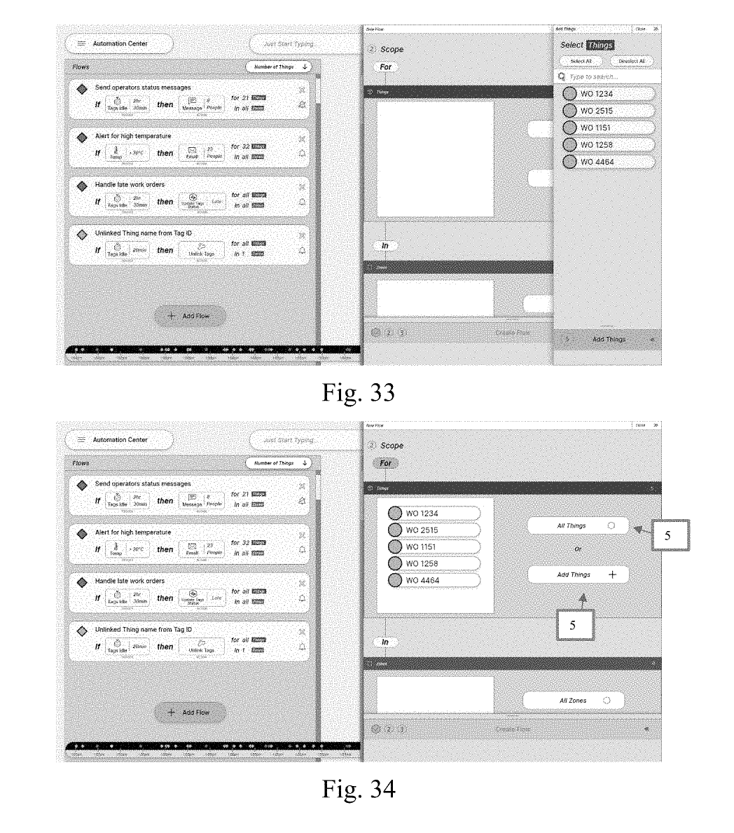

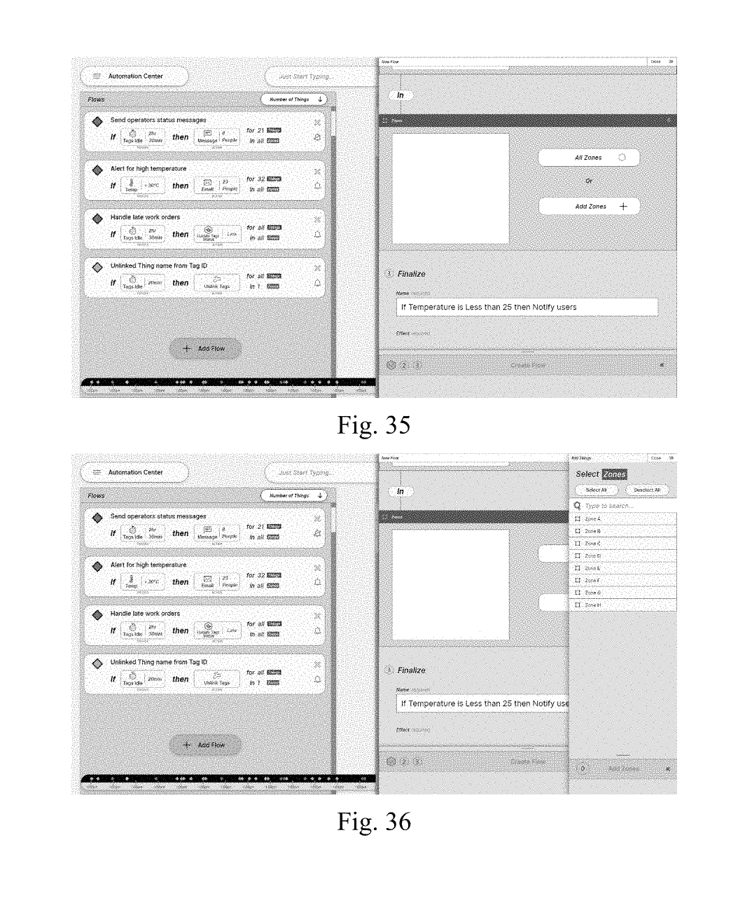

Users can add Things to the Things scope using the Add Things Panel (FIG. 32, FIG. 33) by clicking the Add Things button (58) or by simply adding all Things by clicking the All Things button (59).

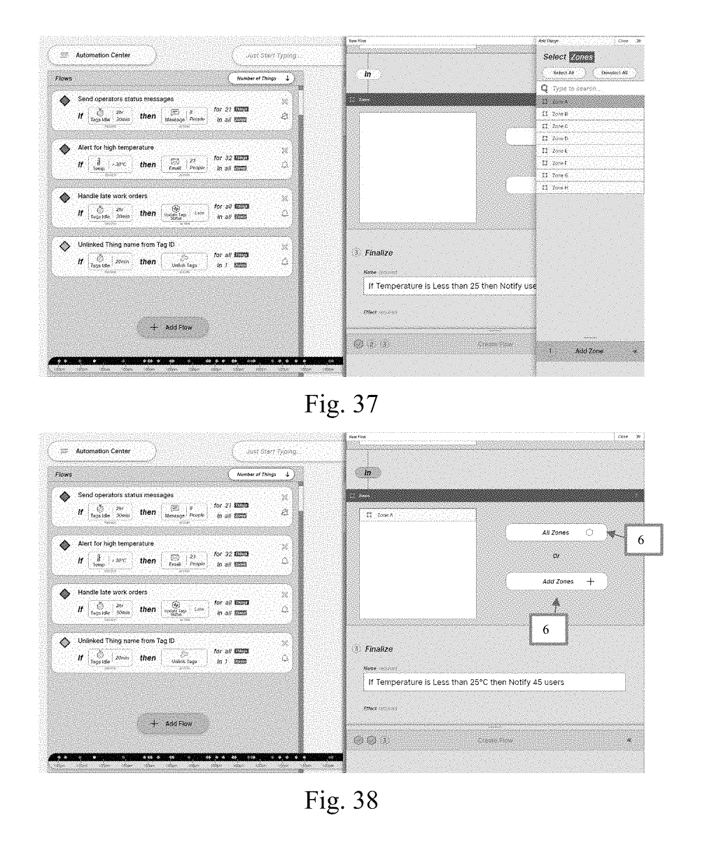

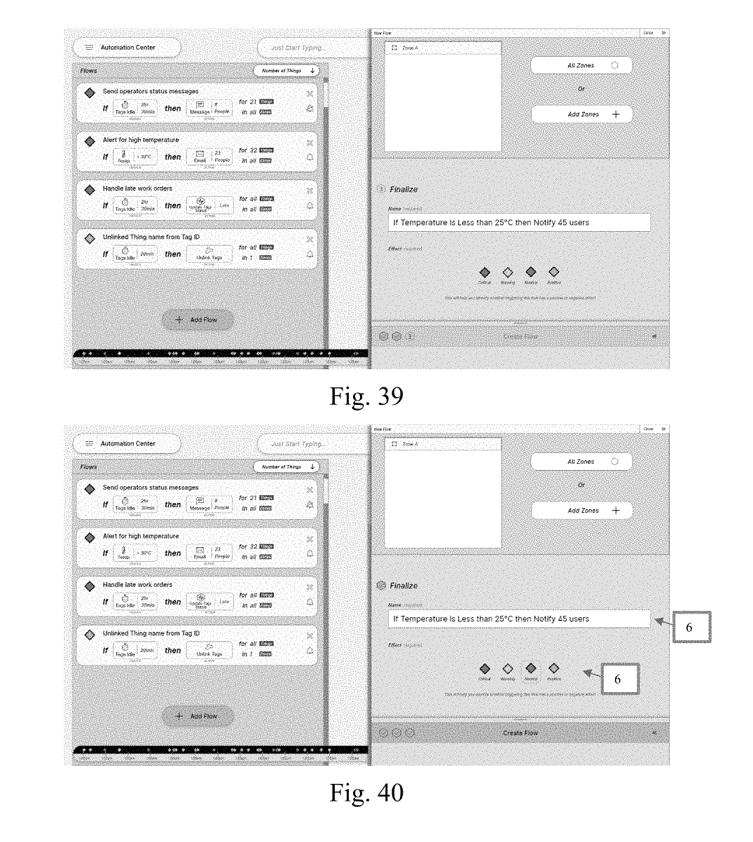

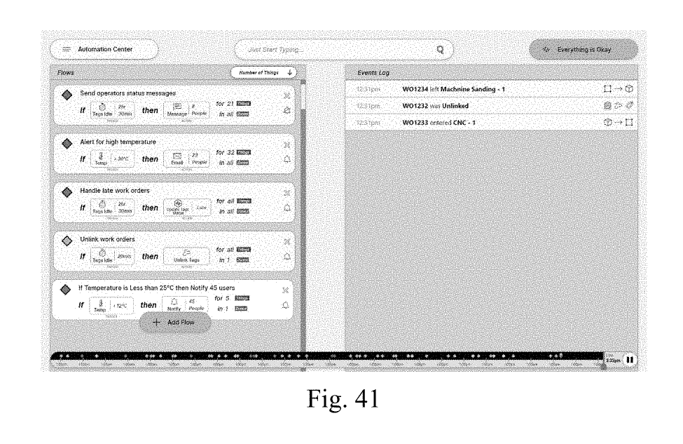

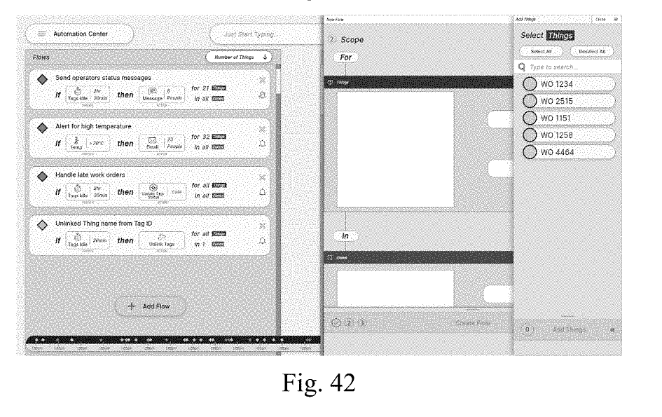

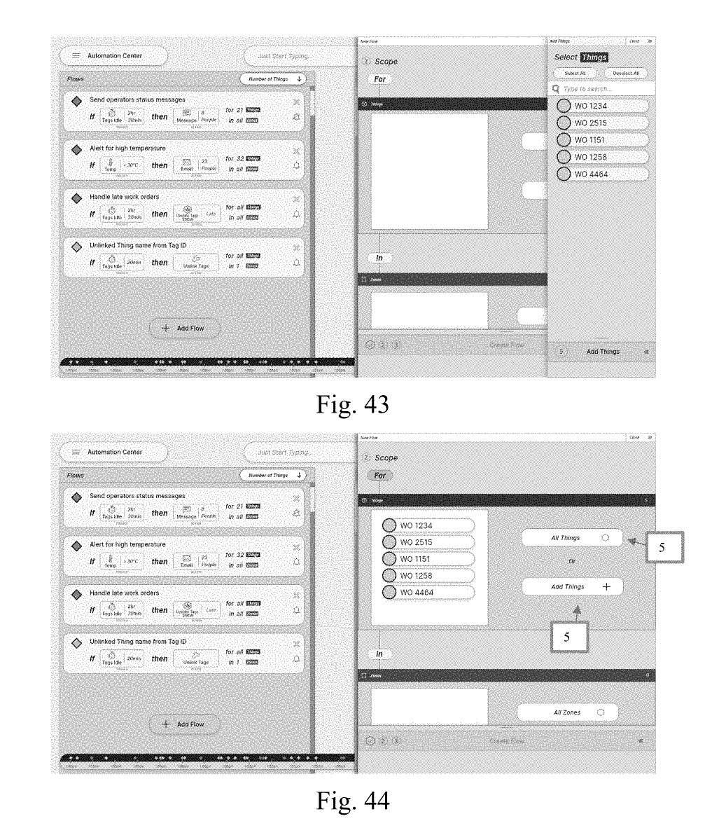

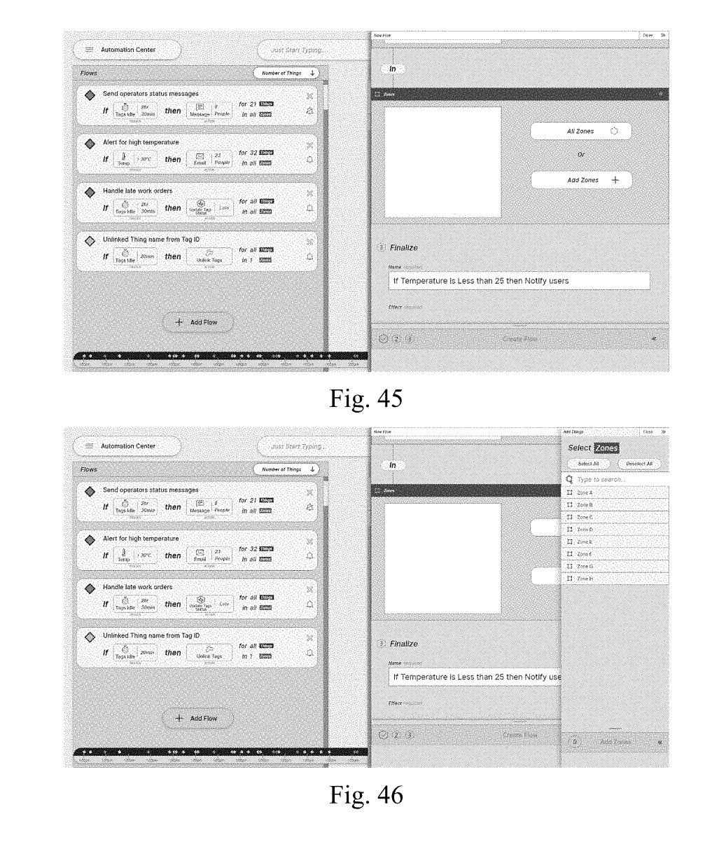

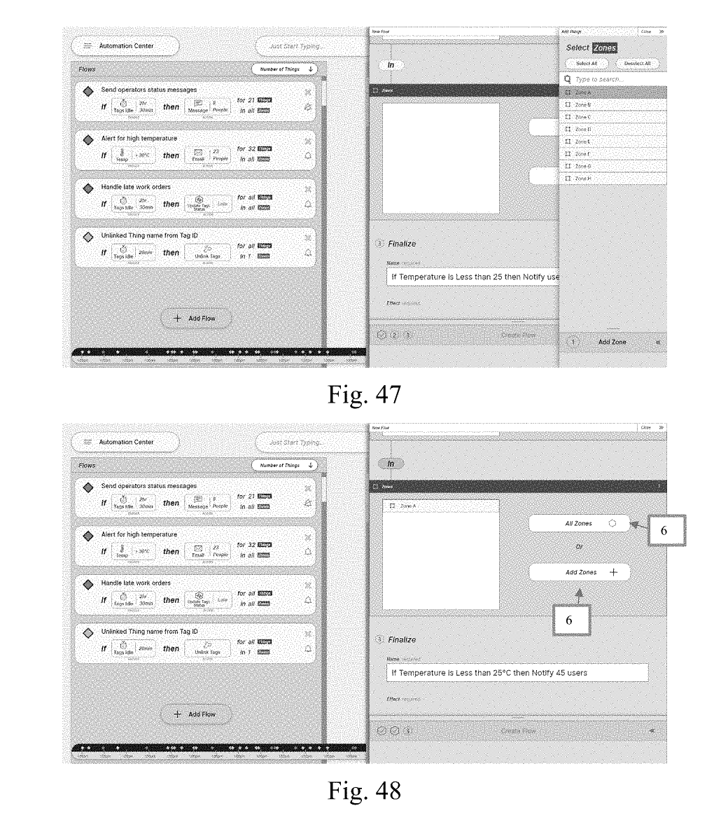

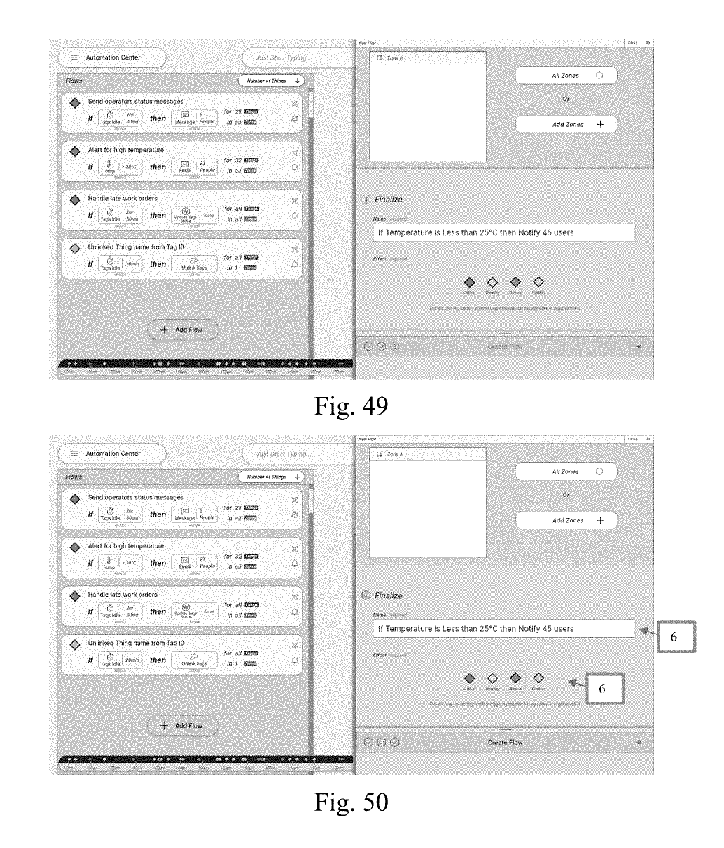

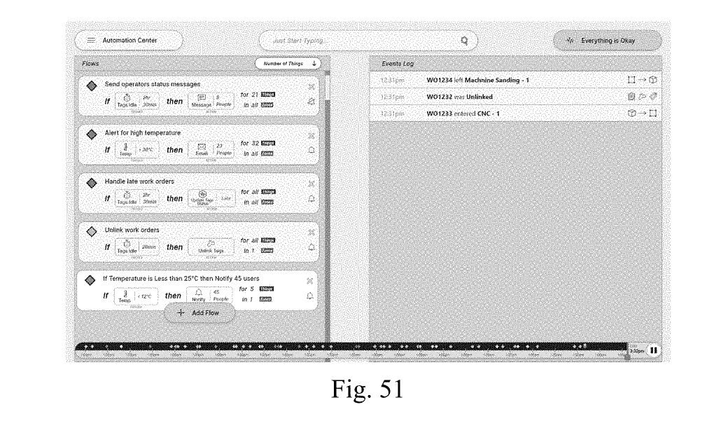

Like setting the scope of Things, users can set the scope of Zones by adding Zones from the Add Zones Panel (FIG. 36, FIG. 37). Users can pick specific Zones to add via the Add Zones button (60) or add all Zones via the All Zones button (61).

Once users have set the scope, they will need to scroll down to finalize the Flow by giving it a Name to describe it (62), and select an effect to visually see the positive or negative effect the Flow has if triggered (63).

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. A method for dynamically spatially visualizing in real time or historically tag localization and sensing data in a User Interface through the combined GUI elements of the Floor Layout view comprising:
a. visually indicating tags as coloured dots on an indoor map view moving within the boundaries of Readers wherein localization data from these tags are used to position and move them in a spatially accurate way; and
b. using playback controls of GUI which allows for pausing or to instantly view historical tag localization and sensing data by dragging the playback control's scrubber backwards in time.

17. A method as set forth in claim 16 including importing editing of and creating Zones through a GUI, which designate a user defined area within the boundary of a fixed, Reader monitored, area.

18. A method as set forth in claim 16 including creating automated workflows using user defined criteria (known as the Trigger), a user defined resulting action (known as the Action) and a user defined scope of which tags and user defined Zones are used to form.
